(19) United States
(12) Patent Application Publication
(10) Pub. No.: US 2004/0155758 A1
(43) Pub. Date: Aug. 12, 2004

(54) Burglar alarm lock for steering wheel of cars

(76) Inventor: Chien-Ho Yu, Tainan Hsien (TW)

Correspondence Address: BIRCH STEWART KOLASCH & BIRCH, PO BOX 747, FALLS CHURCH, VA, 22040-0747, US

(21) Appl. No.: 10/359,116

(22) Filed: Feb. 6, 2003

(51) Int. Cl. B60R 25/10

(52) U.S. Cl. 340/426.31

(57) ABSTRACT

A burglar alarm lock for steering wheel of cars and particularly to a burglar alarm lock aiming at improving U.S. patent application Ser. Nos. 08/616,338 and 824,781 previously submitted by Applicant to enhance theft-deterrent effect and utilization effectiveness. It has a receiving antenna installed on a lock block adjacent to the window of the driver seat at an elevation slightly higher than the lock body. The antenna is connected to an alarm circuit located in the lock set. Through a remote controller and the antenna, the alarm lock may be activated and the alarm may be released at a long distance. The antenna can attenuate the shield effect and improve signal transmission to enhance control effect at a long distance.

### FIELD OF THE INVENTION

The present invention relates to a burglar alarm lock for steering wheel of cars and particularly to a burglar alarm lock aiming at improving U.S. patent application Ser. Nos. 08/616,338 and 824,781 previously submitted by Applicant to enhance theft-deterrent effect.

### BACKGROUND OF THE INVENTION

Applicant has previously submitted patent application Ser. No. 08/616,338 in which a lock body has an outer side plate to couple and lock the steering wheel of a car to restrict the rotation of the steering wheel. The side plate is coupled with a sleeve to control an alarm device to generate audio alarm to prohibit car theft. While such a structure can restrict the rotation of the steering wheel and scare away car burglars by generating audio alarm, it is still not very satisfactory in practical use. For instance, when the outer side plate is unlocked by the key for storing, it may be turned to the lock position and trigger alarm. This creates a lot of annoyances to users. Moreover, the speaker dock for generating sound is a plane structure and is exposed. Car burglars can muffle the speaker with palms or a round cylindrical barrel to reduce the alarming sound. The alarm becomes not very effective.

To remedy the foregoing problems existing in the application Ser. No. 08/616,338, applicant proposed an improvement that focuses on the drawbacks of the outer side plate and speaker dock. The result is application serial No. 824,781 in which the axle of the outer side plate is coupled with a restoring spring and the speaker dock is designed with struts and ribs of different elevations. Thus the problems associated with the outer side plate and speaker dock in the application Ser. No. 08/616,338 were overcome.

While the improvement mentioned above has enhanced the theft retarding effect, there are still some problems occurred on practicality and theft-proof effectiveness. First, the theft retarding and alarming effects of the two cited references is effective starting from thirty seconds after the lock is coupled and locked on the steering wheel. In the event of the car vibrates due to an unlawful external impact or force, the audio alarm is triggered to generate alarming sound after twenty seconds. The audio alarm is stopped after forty seconds. In normal conditions, it is sufficient to scare away burglars. However, if car owners want to return to the car or open the trunk to store or fetch goods in the normal theft-guarding conditions, the vibration occurred could trigger the alarm and produce a faulty alarm. This could be very annoying. Thus either the car owner has to withstand the annoying faulty alarm or the locked alarm has to be released before the car owner entering the car or opening the trunk. This problem causes a lot of inconveniences.

### SUMMARY OF THE INVENTION

Therefore the primary object of the invention is to resolve the aforesaid disadvantages. The invention provides an alarm device that is controlled by a remote controller. The lock alarm is controlled by the remote controller, and the alarm may be released in advance before the car owner entering the car or opening the trunk. Hence the faulty alarm may be avoided. However, the metal shell of the lock body and the metal hood and panels of the car have a shield effect to radio wave that reduces the signal intensity of the remote controller, consequently the remote control distance is limited and the remote controller becomes effective only in a short distance, and theft-deterrent effect is affected indirectly. In severe situations, the emitting signal of the remote controller could become so attenuated such that when the alarm is triggered and alarming sound is generated, the remote controller cannot release or disable the alarm.

Therefore the invention aims at providing an improvement to further enhance the theft-proof effectiveness and practicality of the alarm locks of previous designs. The burglar alarm lock of steering wheel of the invention provides more effective theft-deterrent and may be remotely controlled at a long distance. It aims at achieving the following objects and benefits:

1. The lock body of the invention has a receiving antenna slightly higher than the lock block adjacent to the window next to the driver seat. The antenna is connected to the circuit of the burglar alarm. The antenna can reduce the shield effect and improve signal receiving function. Thus control at a long distance is possible.

2. The antenna frequency of the invention mates the emission signal, thus eliminates the shield effect of the metal shell of the lock body and the metal hood and panels of the car. Control signals are transmitted and received without being hindered. Signal emission and transmission distance may increase.

3. Because the antenna provided in the invention can increase the transmission and receiving distance, approaching of the intruders to the car can be alarmed timely to generate retarding effect and enhance theft-proof effectiveness.

4. The invention enables car owners to temporarily disable the alarm after the car doors and lock have been locked to prevent faulty alarm resulting from shaking of the car doors and to avoid the annoying surprise incurred by the faulty alarm.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a perspective view of the sleeve of the invention.

FIG. 3 is a sectional view of the invention.

FIG. 4 is a schematic view of the invention in an operating condition.

FIG. 5 is a schematic view of the invention in a use condition.

FIG. 6 is a schematic view of the invention in an installed condition.

### DESCRIPTION OF THE PREFERRED EMBODIMENT

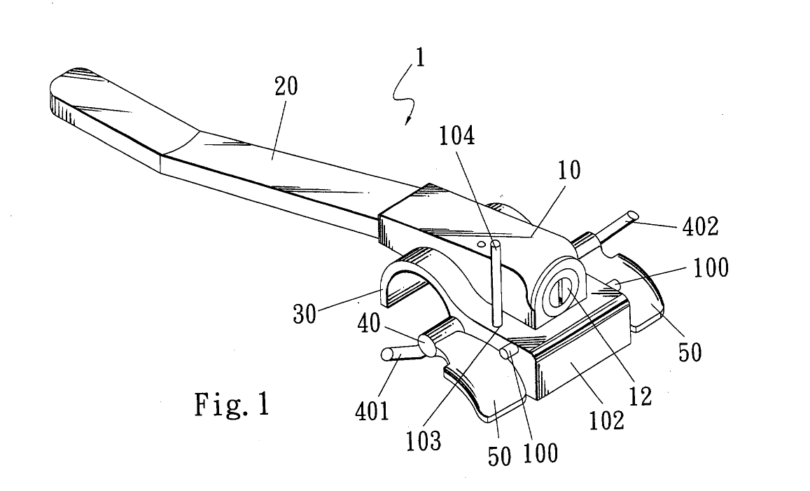

Refer to FIG. 1 for a first embodiment of the invention. The lock set 1 of the car steering wheel includes:

a lock body 10 which has a core 11 located therein for containing a lock mechanism. It has a key way 12 exposing on the front side to receive the key to control the operation of the core 11. The lock body 10 has a lower side extending to form a lock block 102 which has a housing chamber 101 formed therein. The lock block 102 has a screw hole 103 adjacent to the window to couple with an antenna 104. The lock block 102 has two sides extending respectively to form a retaining rod 100, and a tail end extending to form a shell 30;

a harness bar 20 extending from the periphery of the lock body 10 to form a constraint to the turning of the steering wheel;

a shell 30 extending from the lower side of the lock body 10 and having two side walls connecting to the lock body. The lower portion and two sides of the shell are hollow to couple with the annular ring of the steering wheel;

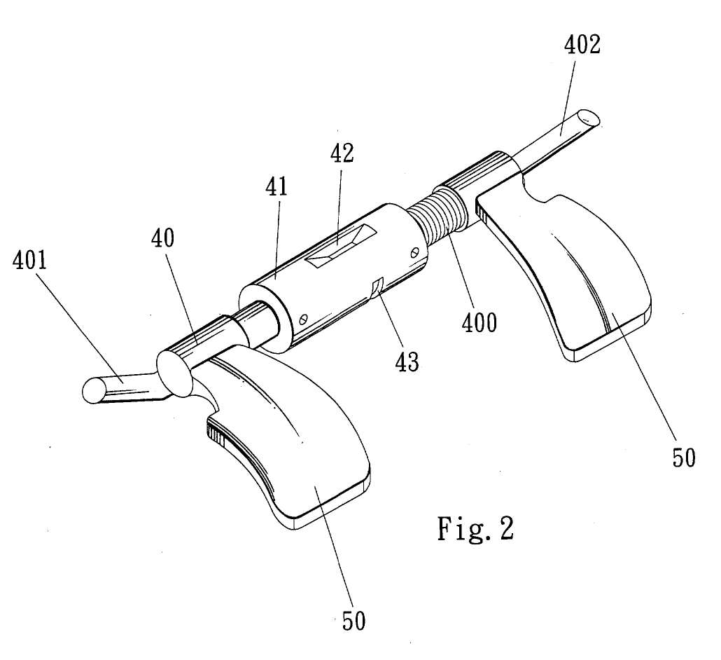

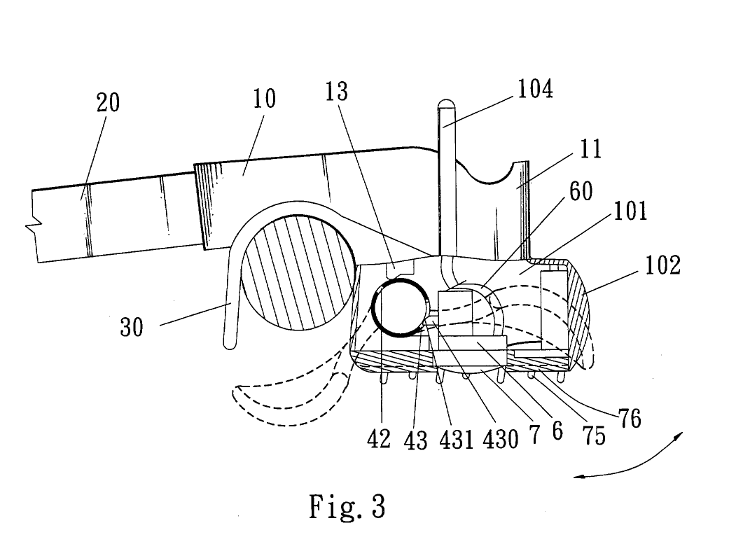

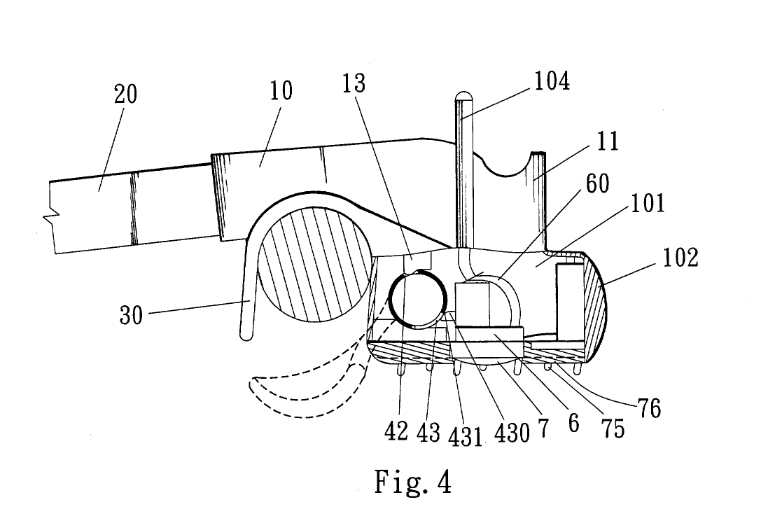

an axle 40 running through a lower section of one side wall and having two ends extending outside the lock block 102. The axle 40 has one side coupling with a restoring spring 400 and a center portion coupling with a sleeve 41 (as shown in FIG. 2). The sleeve 41 has a transverse anchor slot 42 to engage with an anchor strut 13 located in the core 11 for anchoring to achieve the locking effect (as shown in FIGS. 3 and 4). The sleeve further has a longitudinal notch 43 to control ON and OFF of a control pushbutton 430 of the alarm;

two outer side plates 50 fixedly fastening to two ends of the axle 40. The two ends of the axle 40 adjacent to the outer side plates 50 are extended to form bucking rods 401 and 402 that are turnable synchronously with the axle 40. When the outer side plates 50 are turned to the lower end (tail end) and approach another side wall of the shell 30, the axle 40 is controlled by the core 11 to form anchoring (as shown in FIG. 4); and

an alarm circuit device 6 located in the lock body 10 (as shown in FIGS. 3 and 4). Its circuit is connected to a circuit 60 and the antenna 104 to receive signals for transmitting to the alarm circuit device 6. The alarm circuit device 6 connects to a speaker which is mounted onto a speaker dock 7 located on a lower side of the lock body 10. The speaker dock 7 has struts 75 and ribs 76 of various heights located on the periphery thereof and extending downwards to surround the speaker.

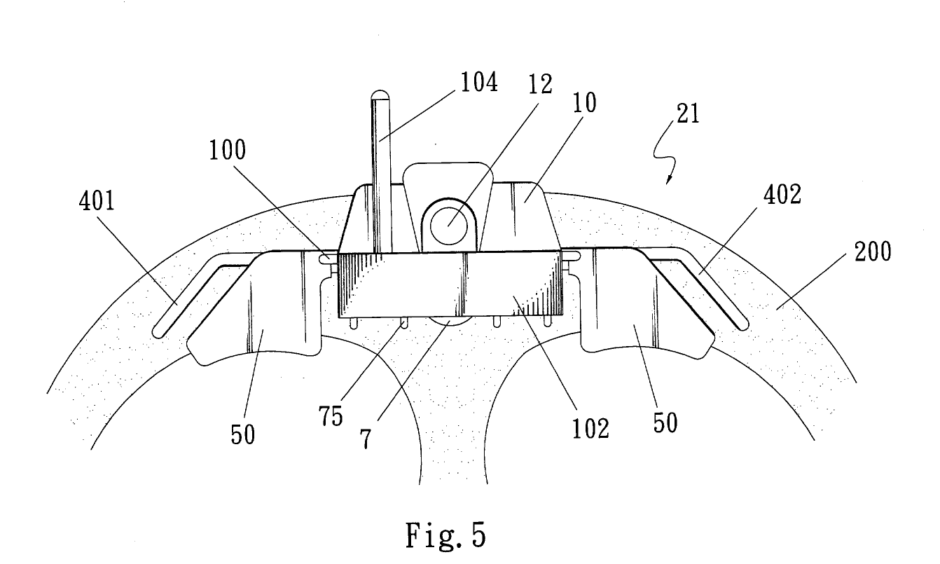

During installation, referring to FIG. 5, after the car is parked and still, directly couple the lock set 1 on the T-shaped steering spoke 20 or annular ring 200 of the steering wheel from above, latch the outer side plates 50 downwards. The outer side plates 50 drive the sleeve 41 rotating until the anchor slot 42 is turned and engaged with the anchor strut 13 of the core 11 to complete the locking condition (shown in FIG. 4).

Meanwhile, the longitudinal notch 43 of the sleeve 41 also is turned. The notch 43 has a sloped surface 431 mating the control pushbutton 430 to control ON and OFF of the alarm signal (referring to FIGS. 3 and 4), thereby the burglar alarm becomes effective and enters a monitoring state.

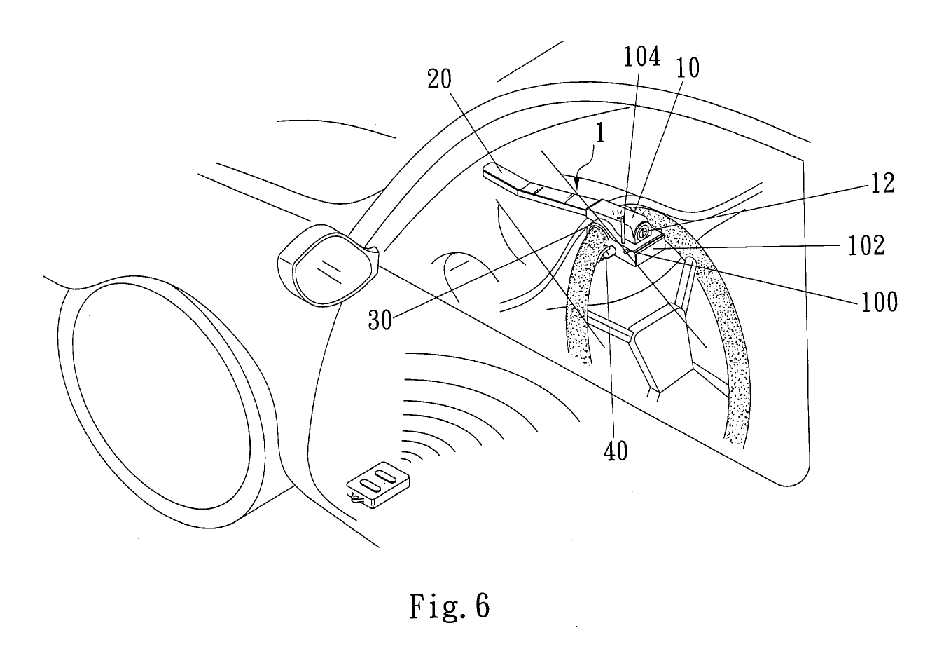

The alarm circuit is located adjacent to the window of the driver seat through the antenna 104 (referring to FIG. 6). It has an elevation higher than the lock block. Thus there is no interruption of shield on the signal transmission path between the remote controller and the antenna. Hence signal is not attenuated. And transmission distance may increase. When the lock set is locked on the steering wheel, user can directly set and activate the alarm through the remote controller, or release the alarm at a long distance for entering the car to tend the articles in the car without being annoyed by the faulty alarm.

What is claimed is:

1. A burglar alarm lock for steering wheel of cars, comprising:
a lock body having a core located in therein;
a harness bar extending from the periphery of the lock body;
a shell extended rearwards from a lock block which is located on a lower side of the lock body;
a lock block extended downwards from the lock body having a housing chamber formed therein;
an axle running through a side wall of the shell and being coupled with a sleeve in the center thereof, the sleeve having an anchor slot to engage with a lock mechanism of the core and a longitudinal notch;
one set of outer side plates fixedly fastening to two ends of the axle and being turnable with the axle; and
an alarm circuit device located in the housing chamber of the lock body and connected to a speaker which is mounted onto a speaker dock and fastened by screws to a lower side of the lock body;
wherein the lock block is engaged with an antenna which is located adjacent to the window of the driver seat at an elevation higher than the lock body, the antenna having a lower end connecting to the alarm circuit device such that no shield interrupting the signal transmission path between the antenna and a remote controller thereby to increase signal transmission distance and control ON and OFF of alarming of the lock at a long distance.
